(19) United States
(12) Patent Application Publication
(10) Pub. No.: US 2005/0189216 A1
(43) Pub. Date: Sep. 1, 2005

(54) Method and apparatus for producing a disinfecting or therapeutic fluid

(76) Inventor: Gennady Krylov, Cambridge (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/044,218

(22) Filed: Jan. 28, 2005

Related U.S. Application Data
(60) Provisional application No. 60/539,328, filed on Jan. 28, 2004.

(51) Int. Cl. C02F 1/461

(52) U.S. Cl. 204/263; 205/755

(57) ABSTRACT

The invention is directed at an apparatus for producing a disinfecting fluid comprising a housing; a brine storage chamber, within the housing, for storing a brine solution; an electrolytic generator within the housing, having a first and a second set of electrodes; and charge means for providing charges to the first set of electrodes to form an anode and the second set of electrodes to form a cathode thereby creating a current field between the anode and the cathode; wherein after the current field is established, the brine solution is transmitted through the current field to ionize ions in the brine solution to produce the disinfecting fluid.

### CROSS REFERENCE TO RELATED APPLICATIONS

This application claims the benefit of U.S. Provisional Application No. 60/539,328 filed Jan. 28, 2004, which is incorporated herein by reference.

### FIELD OF THE INVENTION

This invention relates generally to a system for treating water and, more specifically, a method and apparatus for producing a disinfecting fluid for use in a system for treating water.

### BACKGROUND OF THE INVENTION

In the field of water treatment, chlorine is the most recognized disinfectant with over 98 percent of water treatment systems relying on chlorine to kill various bacteria and viruses. However, it is just one of several water treatment options available to prevent or remove microbial contamination. Ultraviolet light and ozone are often used when it is impractical or hazardous to store and handle chlorine. Ultraviolet light and ozone are very powerful oxidants that kill microbes immediately —often in a matter of seconds—but have short residual time. If the treated water is left unprotected for approximately twenty minutes, it is exposed for possible microbial re-contamination. Chlorine dioxide is another environmentally benign alternative to chlorine. Chlorine dioxide offers a variety of safety and environmental advantages over chlorine and many other commonly used antimicrobial agents, and is four to seven times more effective as a biocide then chlorine at equivalent doses. However, chlorine dioxide is rarely used in smaller-scale operations.

Numerous attempts have been made to replace chlorine as the disinfectant agent to treat drinking water without producing halogenated by-products such as trihalomethanes, dioxins and haloacetic acids. These apparatuses and systems are designed and built based on an electrolysis process to generate chlorine-based oxidants, which can be used for portable, wastewater disinfection or to produce catalytic water for health treatments.

Various prior art systems have one thing in common: they are batch-operated systems that required stopping the water treatment process to discharge a product or interrupting the water treatment process by utilizing a timer circuit to fix the amount of charge that passes through an electrolytic housing. The above-mentioned systems generally consist of a reactor that comprises an anode and a cathode along with a brine solution that is placed between anode and cathode. A ceramic diaphragm is installed between the anode and the cathode to separate zones around the anode and the cathode to produce two electrolytic flows—an anolyte (near the anode) and a catholyte (near the cathode). These systems are very expensive because the anode is manufactured of a combination of materials that usually include a rare earth element such as zirconium or ruthenium. These elements are also not approved for use with food and therefore the water treatment apparatuses have limited applications. Furthermore, in general, only one flow from the apparatus (the anolyte or the catholyte) is used while the other is drained.

Other water treatment systems include electrolysis systems or electrocoagulating systems using ferrous (Fe) or aluminium (Al) electrodes. The electrodes are dissolved inside the electrolyte housing producing a chemical compound such as Fe₂O₃ or Al₂O₃ that is used as the chemical coagulant. However, these systems are not economical as they require a large amount of electricity and the electrodes must be replaced on a regular basis.

It is, therefore, desirable to provide a novel method, apparatus and system for providing a disinfecting or therapeutic fluid and a system for using these fluids.

### SUMMARY OF THE INVENTION

It is an object of the present invention to obviate or mitigate at least one disadvantage of previous apparatus and systems for providing disinfecting or therapeutic fluids.

In an aspect of the present invention, the apparatus is installed “in-line” so that sludge or contaminated water may be disinfected in a continuous process. Also, all by-products produced by the apparatus may also be used for various functions so that no waste is accumulated.

This invention is directed at apparatus and system for producing disinfecting fluid that contains antimicrobial oxidants and is installed “in line” to produce disinfecting fluid, which is environmentally safe, to be injected into a stream of waste or drinking water and provides conditions to disinfect waste or drinking water on site and on demand with no hazardous storage of the concentrated disinfecting fluid.

Another objective of the present invention is to develop an inexpensive method and apparatus that operates in an in-line continuous mode to produce disinfecting fluid on demand in an amount and concentration to neutralize microbial contamination and reduce hazardous storage of concentrated chlor-oxidant fluid. The apparatus preferably produces an environmentally safe, no-health hazard disinfecting fluid, harmless to people and animals. In addition, the apparatus may be used in a coagulating system as a coagulant producer.

In one aspect of the present invention, the disinfecting fluid-producing system advantageously comprises a brine solution tank comprising a perforated baffle to separate bulk salt and brine; an electrolytic housing, equipped with brine control level valve; an electrolytic generator placed inside the electrolytic housing; and an electrical/control box, containing a transformer, a rectifier, an ampermeter, switches and lights.

The electrolytic generator comprises a housing which houses an anode and a cathode. The anode represents a positive electrical terminal and the cathode represents a negative electric terminal.

The anode (preferably cylindrical) is installed inside a corrosion resistant tube that serves as a cathode thus forming a circular space between the two. One of the aspects of the invention are the materials from which the anode and the cathode are manufactured. A highly conductive extruded graphite is preferably used as the anode material and a highly corrosive resistant Hastelloy alloy (Alloy 20) is preferably used as the cathode material. The difference in electrical resistivities of the anode and cathode material assists in the performance of the apparatus. The amount of ions that are formed on the anode and the cathode and their ratio controls the properties of the fluid that comes from the electrolytic housing. Using extruded graphite as the anode material provides better conductivity, because of the electrical resistivity at between 7.99 and 15 ohm-cm×10-⁴ than the cathode material that has an electrical resistivity of around 130 microohms-cm. The larger number of ions on the anode surface produces an anolyte fluid while the ion production on the cathode surface produces a catholyte fluid.

Generally, brine solution enters the circular space between the anode and the cathode, and is charged and ionized by a direct current electrical field (between the anode and the cathode) and transformed into the anolyte, or an acid base disinfecting fluid and the catholyte, or therapeutic fluid. This fluid exits from the top of the generator and enters the fluid flow to be treated. As restricting orifice or the valve controls the flow of the disinfecting fluid.

One aspect of this invention is the transformation of the electrolytic generator, from an anolyte generator into a catholyte generator. The present invention provides a simple, inexpensive transformation from anolyte generator to catholyte generator by installing a larger diametered cathode tube or the small diametered anode.

In another aspect of the invention, a neutral anolyte is produced with a proper amount of the active chlorine to neutralize microbial contamination and oxidize harmful impurities inside waste or drinking water.

In one aspect of the present invention, there is provided an apparatus for producing a disinfecting fluid comprising a housing; a brine storage chamber, within the housing, for storing a brine solution; an electrolytic generator within the housing, having a first and a second set of electrodes; and charge means for providing charges to the first set of electrodes to form an anode and the second set of electrodes to form a cathode thereby creating a current field between the anode and the cathode; wherein after the current field is established, the brine solution is transmitted through the current field to ionize ions in the brine solution to produce the disinfecting fluid.

In another aspect, there is provided an in-line system for disinfecting water comprising a water source; apparatus for producing a disinfecting fluid comprising: a housing, a brine storage chamber, within the housing, for storing a brine solution, an electrolytic generator within the housing, having a first and a second set of electrodes, and charge means for providing charges to the first set of electrodes to form an anode and the second set of electrodes to form a cathode thereby creating a current field between the anode and the cathode; discharge means for discharging the disinfecting fluid; wherein after the current field is established, the brine solution is transmitted through the current field to ionize ions in the brine solution to produce the disinfecting fluid; brine mixing means, connected to the water source, for producing the brine solution for the apparatus; and water disinfecting means for mixing the discharged disinfecting fluid with water from the water source to produce a treated water.

In yet a further aspect, there is provided apparatus for producing a disinfecting fluid and a therapeutic fluid comprising a housing; a brine storage chamber, within the housing, for storing a brine solution; an electrolytic generator within the housing, having a first and a second set of electrodes; and charge means for providing charges to the first set of electrodes to form an anode and the second set of electrodes to form a cathode thereby creating a current field between the first and the second set of electrodes; wherein after the current field is established, the brine solution is transmitted through the current field to ionize negative ions in the brine solution to the anode to produce the disinfecting fluid and to ionize positive ions in the brine solution to the cathode to produce the therapeutic fluid.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective schematic view of an apparatus for producing disinfecting fluid;

FIG. 2 is a sectional view of the apparatus of FIG. 1;

FIG. 3 is a sectional view of an electrolytic generator;

FIG. 4 is a schematic view of a cottage site installation;

FIG. 5 is a schematic view of a point-of-use purifier, under the sink installation;

FIG. 6 is a cross section of the catholyte fluid generator as of the point-of use purifier.

FIG. 7 is a schematic diagram of the point-of-use purifier for office coolers and school, hospital, factory and administrative building drinking water fountains;

FIG. 8 is a schematic diagram of a waste disinfecting installation;

FIG. 9 is a cross section view of a generator for a therapeutic fluid installation;

FIG. 10 is a schematic diagram for the therapeutic fluid application;

FIG. 10A is a sectional view taken along the line A-A of FIG. 10; and

FIG. 11 provides an apparatus for treating water.

### DETAILED DESCRIPTION

Generally, the present invention provides a method, apparatus and system for producing a disinfecting fluid or therapeutic fluid.

In a preferred embodiment, the apparatus in accordance to the invention is directed at producing a disinfecting fluid to neutralize microbial contamination in water and preferably operates in an “in-line” and/or “no waste” mode. By being in-line, the system may be directly connected to a water source and use the water source to produce a disinfecting fluid which assists in the disinfection of the water so that the process may be continuously run or run on-demand. The produced disinfecting fluid is injected into a water or wastewater flow to kill viruses and bacteria in the water or wastewater and to oxidize harmful organic or non-organic compounds in the water or wastewater.

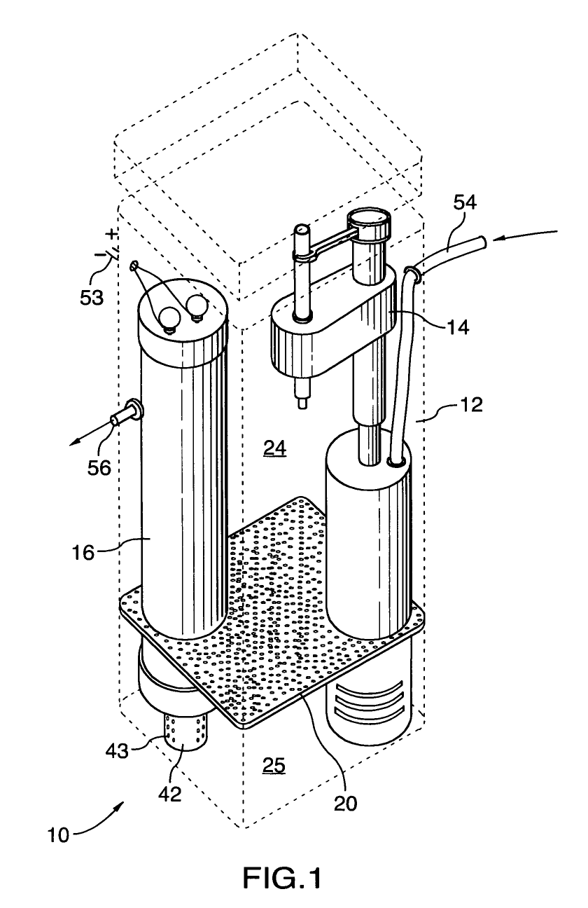

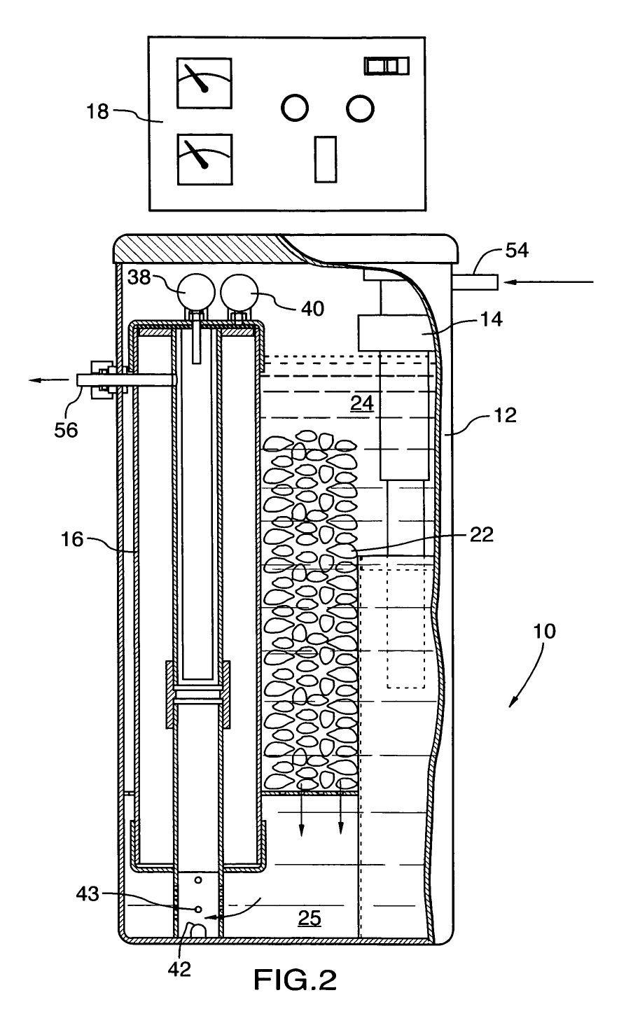

Turning to FIG. 1, a perspective view of apparatus for producing a disinfecting fluid from brine is shown. FIG. 2 provides a cut away view of the apparatus of FIG. 1.

The apparatus 10 comprises a housing 12 comprising a water level control switch 14 and an electrolyte generator 16 (which is controlled by a control panel 18). The housing 12 also comprises a perforated floor 20 atop which a brine salt 22 rests (as shown more clearly shown in FIG. 2). The housing 12 is separated into a mixing chamber 24 and a brine solution chamber 25 separated by the perforated floor 20.

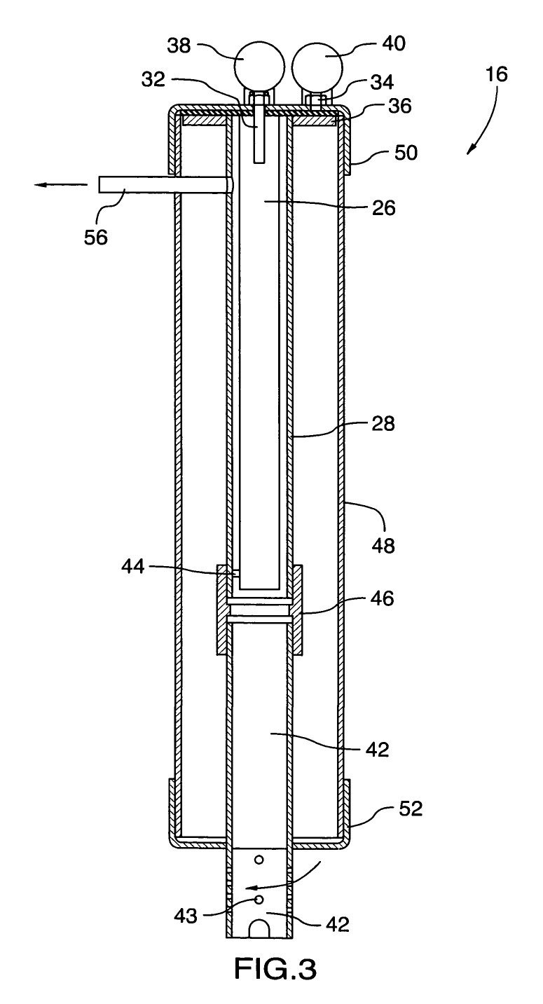

As more clearly shown in FIG. 3, the generator 16 comprises a first set of electrodes (which in operation are provided with a positive charge to form an anode) 26 and a second set of electrodes (which in operation are provided with a negative charge to form a cathode) 28. It will be understood that the set of electrodes may include one or multiple electrodes. The sets of electrodes 26 and 28 are mounted inside an electrolytic housing 30 of the generator 16 by means of studs 32 and 34. In the present embodiment, one stud 32 is connected to the positive electrode 26 by means of a thread and the other stud 34 is connected to the negative electrode 28 by means of welding to an electrode extension 36. Insulating phenolic balls 38 and 40 are installed atop the studs 32 and 34 to prevent accidental touching of the studs by a user. A plastic pipe 42, having holes 43, allows the brine solution to flow from the brine solution chamber 25 to a treatment area between the anode 26 and the cathode 28 through a spacer 44. In order to maintain the cathode 28 and the pipe 42 as a unitary piece, a coupling 46 is used. In order to protect the anode 26 and the cathode 28 from damage, they are stored within a protective case 48 having a top 50 and a bottom 52 cover with the two studs 32 and 34 attached to anode 26 and cathode 28 respectively, mounted on the top cover 50. The protective case 48 and covers 50 and 52 are preferably manufactured from plastic. A pair of wires 53 (as shown in FIG. 1) are connected between the generator 16 and the control panel 18. The control panel preferably includes a positive charge source and a negative charge source to provide the necessary charges to the electrodes to operate the generator 16.

The housing 12 further comprises an intake nozzle 54 for receiving water from a water source along with a discharge nozzle 56 for delivering the disinfecting fluid which is produced by the apparatus.

In operation, the untreated water enters the housing 12 through the nozzle 54 and fills up the inside of the mixing chamber 24. Once the untreated water is delivered to the housing 12, a sensor senses the presence of the water and transmits a signal to the control panel 18 to turn on. The control panel 18 then actuates the positive and negative charge sources to send voltages to the anode 26 and cathode 28 to provide the necessary charges.

The untreated water then mixes with the salt 22, located in the mixing chamber 24, to form a brine solution which enters the brine solution chamber through the perforated floor 20. The perforations in the floor 20 preferably allow the liquid brine solution to travel into the brine solution chamber 25 while restricts the pieces of brine salt 22 from entering the brine solution chamber 25. If the water level within the mixing chamber reaches the water level control switch valve 14, the flow of untreated water from the nozzle 54 is stopped in order to water in the housing 12 from overflowing.

The brine solution then enters the electrolytic generator 16 through the holes 43 in the plastic pipe 42 and the spacer 44 to an electrically charged space (preferably narrow and circular) between the first set of electrodes (anode) 26 and the second set of electrodes (cathode) 28. When the brine solution passes between the charged space, the brine solution is treated by the direct current field and ionized to produce a disinfecting fluid. As a result of this ionization, negative ions, for instance, negative chlor ions and other oxidants such as ozone, chlorine dioxide, oxygen ions are collected on a surface of the anode 26 to produce an anolyte, or disinfecting fluid, and positive ions, such as hydroxyl and hydrogen ions are collected on a surface of the cathode 28 to produce a catholyte, or therapeutic fluid.

During this process, the surface of the anode 26 and the space around the anode 26 becomes an acidic (oxidation) area so that biologic or organic/inorganic contaminants in the brine solution are oxidized and become biodegradable or neutralized. Also, the surface of the cathode 28 and the space around the cathode 28 become alkaline to provide a bio stimulating (reduction potential) area.

In an embodiment, the specific ratio between the anode 26 and the cathode 28 surfaces is equal to 91.15% producing a disinfecting fluid with a pH in the range from 7.8 to 8.5. The ratio represents the size of the surface of the anode used in ionization/size of surface of the cathode used in ionization.

The properties of the anolyte and catholyte are determined by the space between the anode and cathode and also the size of the anode. A larger anode surface allows for more oxidation to occur and therefore properties, such as the pH level may be controlled by the size of the first set of electrodes (anode) and the second set of electrodes (cathode) and the space (current field) between the sets of electrodes.

The discharge nozzle 56 is preferably located one inch below the nozzle 54, on a side of the housing 12 opposite the nozzle 54. The discharge of the disinfecting fluid is generally performed utilizing the U-tube effect, which will be known to one skilled in the art. This allows the disinfecting fluid to be discharged from the housing 12 without any extra pressure. The time period in which the brine solution, or any other fluid, remains inside the electrolytic generator 16 is pre-determined in order to produce a disinfecting, or other, fluid with specific qualities. For instance, when the apparatus 10 produces a disinfecting fluid with an Active Chlor of 500 milligram per litre, the apparatus 10 consumes around 300 watts of power with a generator 16 being one and a quarter inches in diameter, twelve inches high and a flow of 60 litres per hour.

The apparatus of this embodiment also produces a catholyte (bio stimulating) fluid by the brine solution (having of 204 mg per litres total dissolved solids—TDS) through the electrically charged space between the anode 26 and the cathode 28. In order to achieve this result, the surface ratio of the anode 26 and the cathode 28 should be 91.15%, the amperage of the charges between 4.5 and 6.25 amps, the treated fluid capacity between 12 and 35 L per hour, redox potential from −467 to −304, a pH from 7.3 to 8.2 and active chlorine of 20 mg/L.

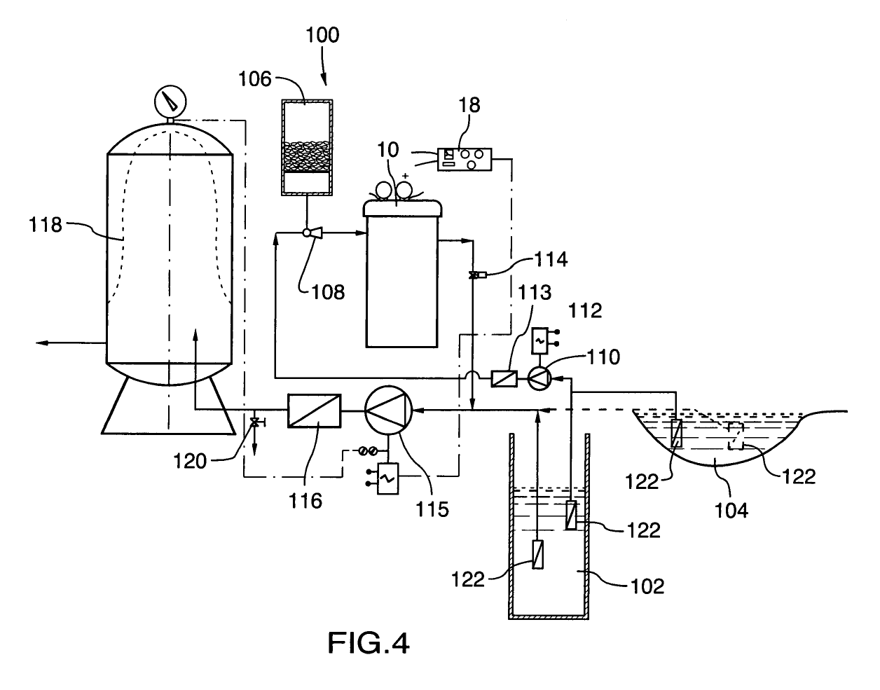

Turning to FIG. 4, a schematic diagram of a first embodiment of a system for treating water is shown. In this embodiment, the system 100 is installed in a cottage site and comprises the disinfecting fluid apparatus 10 installed in an “in line” mode which operates to produce a disinfecting fluid which is to be injected back into the water flow in order to neutralize microbial contamination inside the water to provide, among other substances, drinking water which is free of microbial contamination for consumption by humans or animals.

In many cottage settings, water is supplied from a well 102 or an open surface water location 104 such as a lake or a pond. Additionally, the disinfecting fluid produced by the disinfecting fluid apparatus 10 may be used to clean the walls of the well 102 to remove contaminated substances, such as microbial contamination or algae. The system 100 may also comprise a tank 106 which houses a concentrated brine, such as a potassium chloride or sodium chloride concentrated brine. An injector 108 controls the flow of brine from the brine tank 106 in a predetermined amount to supply 1-3% concentrated brine to the apparatus 10. The level of water in the mixing chamber (as determined by the control water level valve switch 14 in the housing 12) controls the delivery of brine from the tank 106

The control water level valve 14 closes the brine supply flow once a predetermined water level within the housing 12 is reached. At this point, the apparatus 10 is ready for operation and the electrolyte generator 16 may be switched on as sensed by the sensors.

The system 100 also comprises a pump 110 which controls the flow of water from the well 102 or the open surface water location 104 (which contains the untreated water) to the housing 12 within the disinfecting apparatus 10 along with sending a signal via a control circuit 112 to the control panel 18 which controls the generator 16 within the apparatus 10. A first media filter 113 is located between the pump and the apparatus 10.

A regulating valve 114 is located between the discharge nozzle 56 and the water flow in order to control the amount of disinfecting fluid which is introduced to the water flow to treat the water. The system 100 comprises a second pump 115 along with a second media filter 116 between the second pump 115 and a treated water reservoir 118. A probe valve 120 may also be included to allow for analysis of the treated water.

In order to prevent debris from entering the water flow, intake water strainers 122, such as foot valves, may be located in the well 102 and/or open surface water location 104.

In operation, the system 100 starts when the pressure inside the water reservoir 118 drops below a predetermined value, such around as 40-45 PSI. The water reservoir 118 is generally used to store previously treated water so that there is little delay in delivering treated water to a user when the user requests water. Once the water level, or pressure, drops below the predetermined value, the pump 110 (preferably submersible) is triggered, which, in turn, sends a signal from the control circuit 112 to the control panel 18 to send charges to the electrolytic generator 16 in the apparatus 10.

After the pump 110 starts, water is pumped from the well 102 or open water surface location 104 to the apparatus 10. Simultaneously, the concentrated brine is discharged from the brine tank 106, via the injector 108, to the mixing chamber 24 within the housing 12 of the apparatus 10 to produce a brine solution between the concentrated brine the water from the water source. In this embodiment, for practical reasons, the salt/concentrated brine is not located within the mixing chamber 24 since it would be tougher to replenish the salt once it has been used up. Therefore, the salt/concentrated brine is remote from the apparatus for easy replenishment when the tank needs to be refilled. It will be understood in another embodiment of the system 100, the apparatus 10 may include brine salt within the mixing chamber as described above with respect to FIG. 1.

As described above, the brine solution passes through the charged space between the anode 26 and the cathode 28 of the generator to produce a disinfecting fluid. The disinfecting fluid is then discharged from the housing 12 of the apparatus 10 to the regulating valve 114, in a predetermined amount which is required to disinfect the incoming water flow from the well 102 or open surface water location 104. In one embodiment, the preferred disinfecting fluid flow rate is approximately 15 litres/hour with an active chlorine of about 350 mg/L injected into the supplied water flow of ten gallons per minute.

Once the disinfecting fluid is received at the regulating valve 114, a signal is sent to the second pump 115 to begin pumping water from the well 102 or open surface water location 104. The disinfecting fluid is then mixed with the water flow to treat the water. The treated water is then passed through the second media filter 116 to the water reservoir 118 where it is held under a pressure of approximately 30 to 45 psi (pounds per square inch) for a predetermined time before the treated water may be consumed.

The process is then repeated when the pressure inside the water reservoir 118 drops past the predetermined value.

In normal operation, the water flow is set at a consistent rate andthe amount of contamination from the water source (the well 102 or open water surface location 104) remains a constant. Therefore, the injector 108 may be pre-set to deliver a set amount of brine solution (at the predetermined concentration of brine) via a formula calculated with respect to rate of water flow and level of contamination which produces a disinfecting fluid having the required properties to treat the water. The amount of disinfecting fluid that is produced and discharged back into the water flow is also determined by the to rate of water flow and level of contamination of the water. The regulating valve 114 releases the disinfecting fluid in relation to the calculated amount. Therefore, these calculations may be performed prior to the operation of the system. So that the system may be continuously operated.

In an alternative embodiment, the regulating valve may include a processor which performs automatic calculations as to the amount of disinfecting fluid to be discharged into the water flow by using sensors to monitor the variables such as rate of water flow and level of contamination of the water.

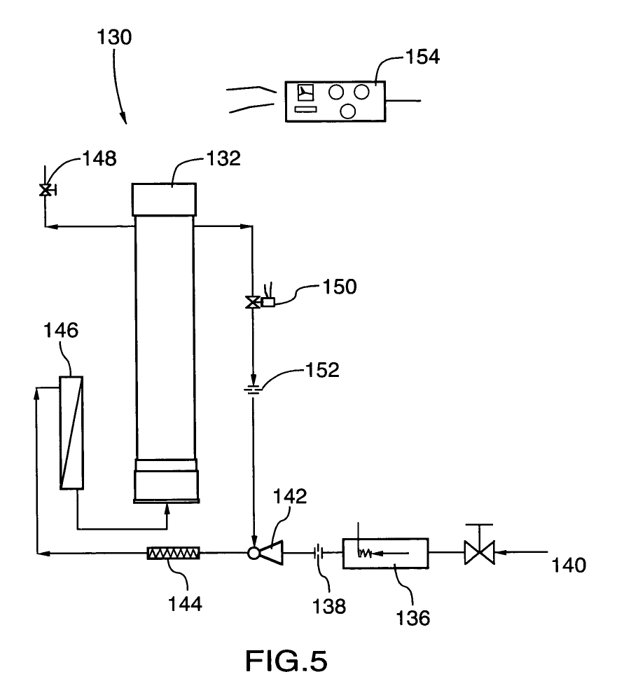

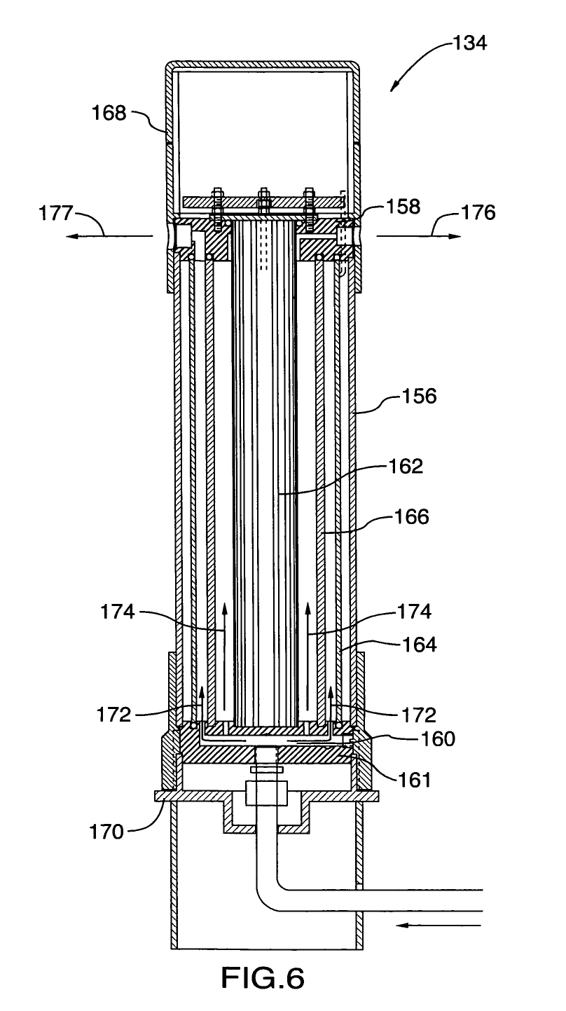

FIG. 5 is a schematic diagram of a non-waste system for treating water whereby drinkable water is supplied to an end user. In this embodiment, the disinfecting fluid apparatus is a point-of-use apparatus which may be installed under a sink in a kitchen. The system 130 comprises a disinfecting apparatus 132 comprising an electrolytic generator 134 (as shown in FIG. 6). The system 130 further comprises a flow switch 136, a first restricting orifice 138, an injector 142, a motionless mixer 144 and a media filter 146, located between a city water supply 140 and the disinfecting apparatus 132. A second restricting orifice, or regulating valve, 150 and a third restricting orifice 152 are preferably located between a discharge nozzle 176 (shown in FIG. 6) of the apparatus 132 and the injector 142. Control of the electrolytic generator 134 is via a control panel 154 located remote from the apparatus 132 but, preferably, in wired communication. The electrical box and control panel 154 comprises electrical and control components to start and control the water treatment process along with providing a positive and negative charge source to charge the first set of electrodes and second set of electrodes to become an anode and cathode. A water tap 148 controls the requesting of the treated water.

As shown in FIG. 6, which is a sectional view, the electrolytic generator 134 comprises a housing 156, top 158 and bottom 161 mounting plates, a water distributor 160, a first set of electrodes which form anode 162, a second set of electrodes which form a cathode 164, a diaphragm 166, a top cover 168 and a bottom cover 170.

Water flows from the city water supply 140 as soon as the water tap 148 is opened. The water flow triggers a sensor (not shown) within the flow switch 136, which, in turn, sends a signal to the control panel 154 which provides the necessary charges to charge the electrodes in the electrolytic generator 134. The water then flows through the first restricting orifice 138 and the injector 142 before passing by the motionless mixer 144 and the media filter 146 before entering the housing 156.

Once the water enters the housing 156, the water is divided into two flows by the water distributor 160 inside the bottom mounting plate 161 with the first flow indicated by arrows 172 and the second flow indicated by arrows 174. One flow 174 enters the circular space formed by the anode 162 and the diaphragm 166 while the second flow 172 enters the circular space formed by the diaphragm 166 and the cathode 164. The water flow 174 that passes through the space formed by the anode 162 and the diaphragm 166 is treated by a direct current field (created by the charges sent by the control panel 154) to produce an anolyte seen as an acidic, disinfecting fluid. This disinfecting fluid is then discharged via the anolyte discharge nozzle 176 to the regulating valve 150 which delivers the fluid to the injector 142 via the third restricting orifice 152. The injector 142 then combines the water flow and the disinfecting fluid and transmits this combination to the motionless mixer 144 where the water is treated and returned to the apparatus 132. The mixing assists in neutralizing any microbial or organic contamination inside the water from the city water supply 140.

After passing between the cathode 164 and the diaphragm 166, the positive ions in the water flow 172 are ionized to the cathode and the resulting catholyte discharged via the catholyte discharge nozzle 177 and delivered to a tap where the catholye may be used for drinking or any other use. The water flow 172 that passes through the charged space formed by the diaphragm 166 and the cathode 164 becomes a bio stimulating flow which is an alkaline base fluid or catholytic water with a pH between 7.8 and 8.5 and a redox between −100 and −250 millivolts (which is comparable with the inner electrical charge of the human body). As a result of this reaction the active reduction potential ions of OH⁻, H₃⁻, O₂⁻, H, HO₂⁻, O₂⁻, are formed.

The purpose of the semi-permeable diaphragm 166 is to prevent OH⁻ ions from entering the space between the anode and the diaphragm which would neutralize the active oxidants. The diaphragm keeps the anolyte (acidic) flow and catholyte (alkaline) flow apart, so that each flow maintains their expected properties.

The process stops once the tap 148 is closed but re-starts when the tap 148 is re-opened.

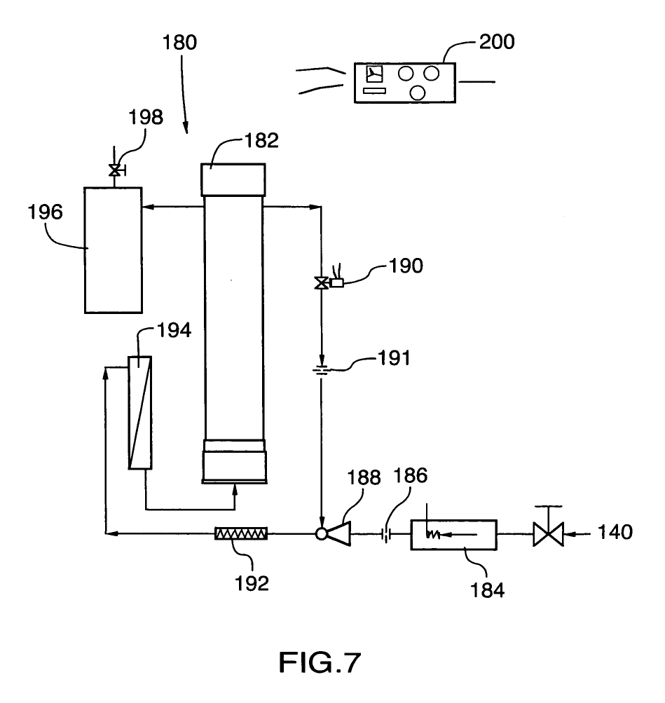

FIG. 7 is a schematic diagram of yet a further embodiment showing a point-of-use water treatment system for installation in an office water cooler, or water fountains in a school, hospital, factory or administrative building. The system 180, which is similar to the embodiment of FIG. 5, comprises an electrolytic housing 182, a flow switch 184, a first restricting orifice 186, an injector 188, a solenoid, or regulating, valve 190, a motionless mixer 192, a media or carbon filter 194, a cooler or fountain 196, a water tap 198, and an electrical/control panel 200.

The water tap 198 triggers the flow switch 184. A sensor, within the flow switch, senses water flow, and transmits a signal to the control panel to send charges to an electrolytic generator in the electrolytic housing 182 and opens the solenoid, or regulating, valve 190. After the disinfecting fluid has been produced (in a manner similar to the one described above), the disinfecting fluid is injected into the incoming water flow through the injector 188.

The combination of the water flow and the disinfecting fluid is then mixed within the motionless mixer 192 and passes by the filter 194 before re-entering the electrolytic housing 182.

The catholyte which is produced is then used to supply treated drinking water to the water cooler or fountain 196.

In operation of the present invention, electrolysis is the preferred technology for changing the properties of the brine solution, however, other technologies may also be used. The electrolysis process uses an electrolytic cell with anode, cathode, aqueous solution and direct electrical current as described with respect to the apparatuses above. The brine solution changes its properties when passing through the charged space between the positively charged anode and the negatively charged cathode. Under the specific conditions reduction-oxidation chemical reaction takes place inside the electrolytic cell. As a result aqueous solution (water) produces active ions inside the anode and the cathode chambers. The chemical reactions may be described as follows:
1. Water oxidation on anode: 2H₂O−4e=>4H+O₂
2. Cathodic water reduction: 2H₂O+2e=>H2+2OH
3. Gas Chlorine formation on anode: 2Cl−2e=>Cl₂
4. Highly active oxidants inside the anode housing: Cl₂O, ClO₂, ClO⁻, HClO, Cl, O₂, O₃, HO₂, OH
5. Cathode reduction inside cathode housing: OH⁻, H₃⁻, O₂⁻, H₂, HO₂

The strong oxidants inside the anode housing transform water into the acidic fluid (anolyte) with a strong oxidation properties, and the active reduction ions on the cathode transform water into the alkaline fluid (catholyte) with active chemical-absorption, bio-stimulation, strong detergent properties. Anolyte and catholyte have different parameters in respect of pH and redox potential (ORP) data. Anolyte (acid) has pH in a range from 0 to 6.0, catholyte (alkaline) from 8.0 to 13.0 and ORP from 100 to 4,000 for anolyte and from −100 to −800 for catholyte.

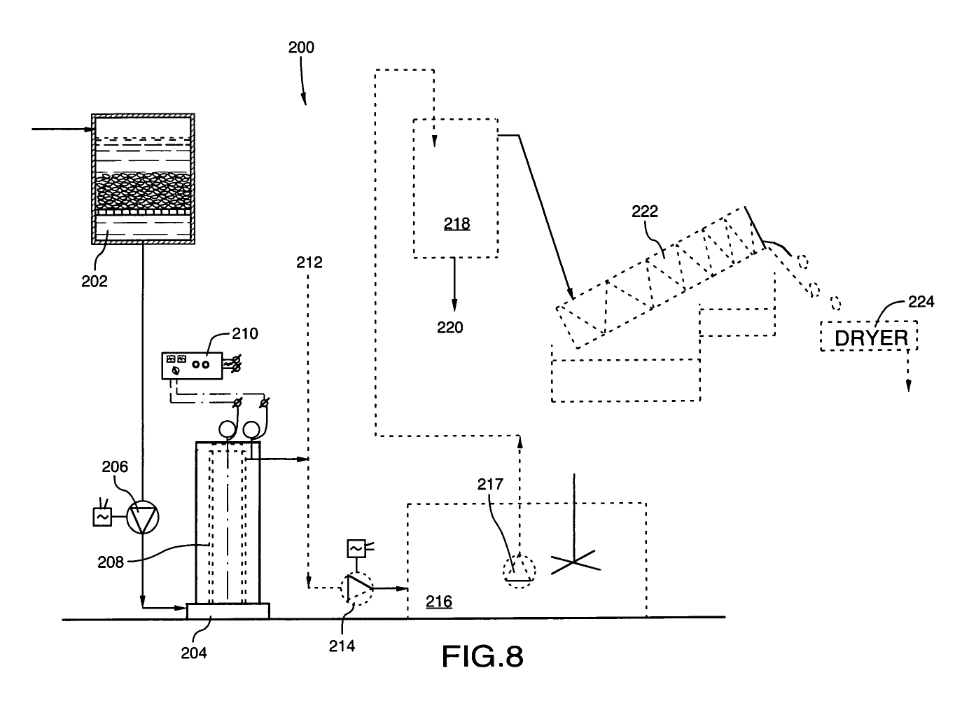

FIG. 8 shows a schematic diagram of a system for a liquid waste disinfecting process. The system 200 comprises a brine tank 202 which houses a salt or concentrated brine along with a disinfecting fluid apparatus 204 with a pump, or injector, 206 connected therebetween. The injector 206 is also connected to a control circuit 208 which transmits signals to a control panel 210 controlling the disinfecting fluid apparatus 204. The output of the disinfecting fluid apparatus 204, along with material from an oxidation ditch 212, are connected to a sludge feed pump 214. The output of the sludge feed pump 214 is connected to a sludge tank 216 which feeds a flocculation tank 218. The flocculation tank 218 is connected to a drain 220 and a dewatering drum 222 which disposes of its solid water into a dryer 224.

In operation, water is added to the concentrated brine (for example 3-6% of NaCl in water) in the brine tank 202 to produce a brine solution. The brine solution is then pumped (by the pump 206) from the brine tank 202 to the disinfecting apparatus 204. Once the pump 206 begins to pump the brine solution, the control circuit 208 transmits a signal to the control panel 210 instructing the control panel to transmit charges to the electrodes in the disinfecting fluid apparatus 204 as described above. After the brine is transmitted in the charged space between the anode and cathode of the apparatus 204 (as described above), to produce a disinfecting fluid, the disinfecting fluid is discharged from the apparatus 204 and enters the suction side of the sludge feed pump 214. The disinfecting fluid and liquid sludge from the oxidation ditch 212 are mixed inside the sludge feed pump 214 to form a disinfected sludge which is then sent to the sludge tank 216 The disinfected sludge is then pumped out from the sludge tank 216 by a pump 217to the flocculation tank 218. The rest of the liquid water removal process will be well known to one skilled in the art. The concentration of the disinfecting fluid is maintained by the fluid flow, brine concentration and may be adjusted by simply changing the concentration level of the concentrated brine in the brine tank 202.

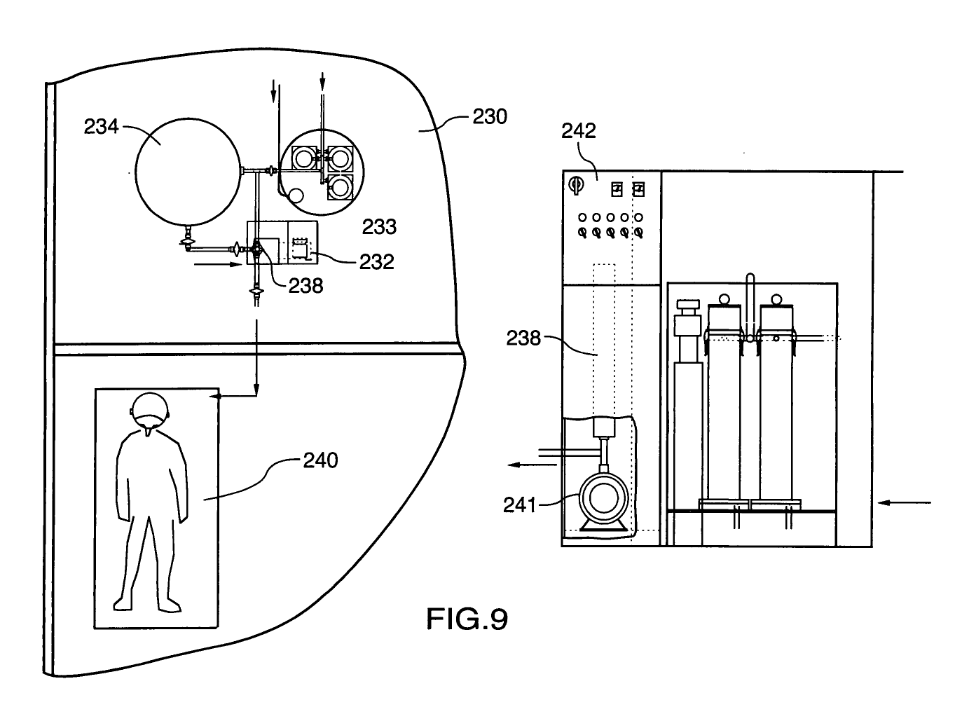

A schematic diagram of a therapeutic installation for a water treatment system is shown in FIG. 9. In this embodiment, one aspect is to produce a bio stimulating fluid (catholyte) with a negative redox of −600 to −750 millivolts and a pH of 9.5 to 11.5. The catholytic fluid with such parameters may be used as an external water therapy fluid to enhance human body processes. In the previous embodiments, after the brine solution was charged, the anolyte was used as the disinfecting fluid while the catholyte remained unused although it may have been discharged for use. In this embodiment, the catholyte produced by passing the brine through the charged space between the anode and cathode of the disinfecting apparatus rather than the anolyte.

The system 230 comprises an electrolytic generator 232 within a therapeutic fluid apparatus 233, a storage tank 234, a pump 236, a heater 238, a bath or Jacuzzi 240, a pump 241, an electrical/control panel 242 and piping & fittings for connecting each of the parts of the system 230.

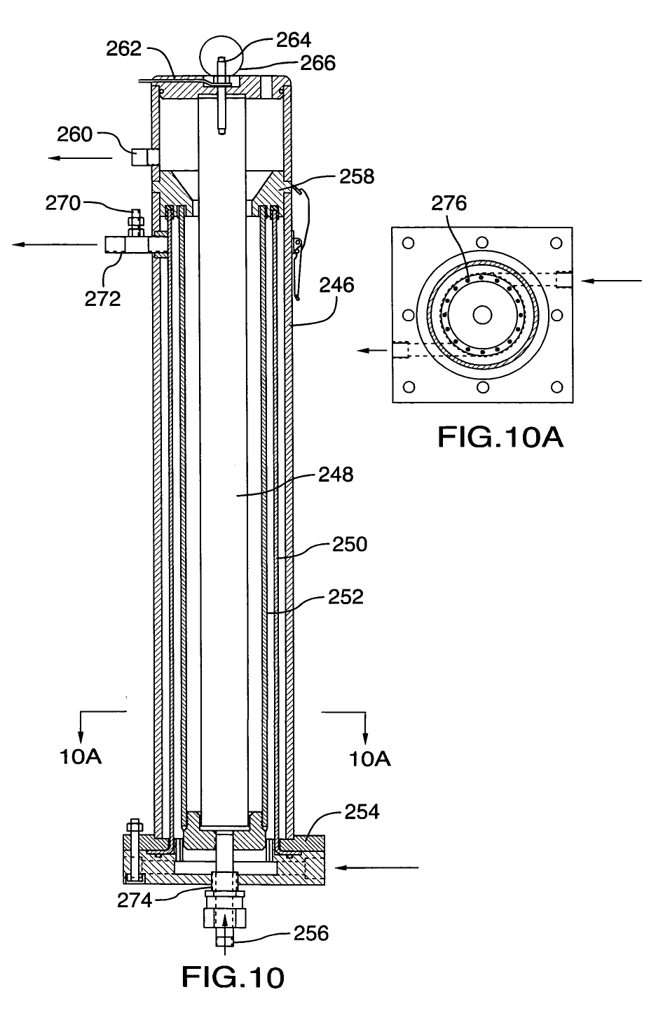

A sectional view of the electrolytic fluid generator 232 is shown in FIG. 10. FIG. 10A is a cross-sectional view taken along the line A-A of FIG. 10. The generator 232 preferably comprises a housing 246, a first set of electrodes (anode) 248, a second set of electrodes (cathode) 250, a diaphragm 252, a bottom plate with water inlet 254, a brine solution inlet 256, an anolyte (top) housing 258, an anolyte discharge nozzle 260, a top cover 262, an electrical contact (stud) 264, an insulating phenolic ball 266, an o-ring 268, a cathode electrical stud 270, a catholyte discharge nozzle 272 and a compression fitting 274.

In this embodiment of the invention, the generator preferably comprises an inexpensive molded graphite material for the anode, an inexpensive ceramic (kaolin type) as the material for a semi-permeable diaphragm and a highly anti-corrosive material for cathode that allows for the use of a polarization switch for cathode/anode surface cleaning.

In operation, water enters the generator 232 through the nozzle 254 which is preferably arranged tangentially with respect to the cathode 250. The water is then pressured into an electrically charged circular space through holes 276, preferably, drilled at an angle of 15° to the bottom of the plate 254. The tangential arrangement of the holes 276 causes water to whirl in the circular space between the surfaces of the diaphragm 252 and the cathode 250 to provide better flow movement near the electrically charged surfaces and to improve ion exchange.

While the water is entering the charged space between the cathode and the diaphragm, a concentrated brine, preferably 3-6% NaCl or KCl in water, enters the generator 232 through the nozzle 256 and enters the electrically charged circular space between the anode 248 and the diaphragm 252. It will be understood that the charged spaces are created by the control panel sending charges to the electrodes in the generator.

The therapeutic fluid (produced by the electrolytic process between the cathode and the diaphragm) is then discharged from the generator 232to the storage tank 234. The therapeutic fluid then is heated (if needed) by the heater 238 to a predetermined temperature before being pumped into the bath 240. The pump 241 and the electrical heater 238 are used to heat up and circulate the therapeutic fluid in the tank 234 After the bath 240 has been filled with the therapeutic fluid, the bath may be used for therapeutic relief.

During the electrolytic process, water is oxidized on the surface of the anode 248, for instance, 2H₂O−4e=>4H⁺+O₂ and on cathode surface, as of 2H₂O+2e=>H₂+2OH.

In the case where brine solutions such as NaCl and KCl are used, active chlorine (Cl₂) is formed on the anode surface, due to the reaction 2Cl−2e=>Cl₂. The highly active oxidants, such as Cl₂O, ClO₂, ClO⁻, HClO, Cl, O₂, O₃, HO₂, OH are formed inside the anode circular housing (area between anode and diaphragm surface). The cathodic reduction reaction takes place inside the cathodic housing (area between cathode and diaphragm surface). As a result of this reaction, highly active reduction potential ions of OH, H₃⁻, O₂⁻, H₂, HO₂⁻, O₂⁻ are formed. An advantage of the semipermeable diaphragm is to prevent ions of OH⁻ to enter the anode housing which would neutralize the active oxidants so that the diaphragm keeps the anolyte (acidic) flow and catholyte (alkaline) flow apart allowing each flow to serve their purposes. In such a design, the catholyte generator produces therapeutic catholyte with a pH between 9.5 and 11.5 and redox between minus 700 and 850 millivolts. At the same time the generator produces the disinfecting fluid (anolyte) for the microbial de-contamination.

The disinfecting fluid (anolyte) produced between the anode and the diaphragm may be used as an antiseptic fluid for disinfecting purposes. It may also be collected and applied externally to treat some skin disorders.

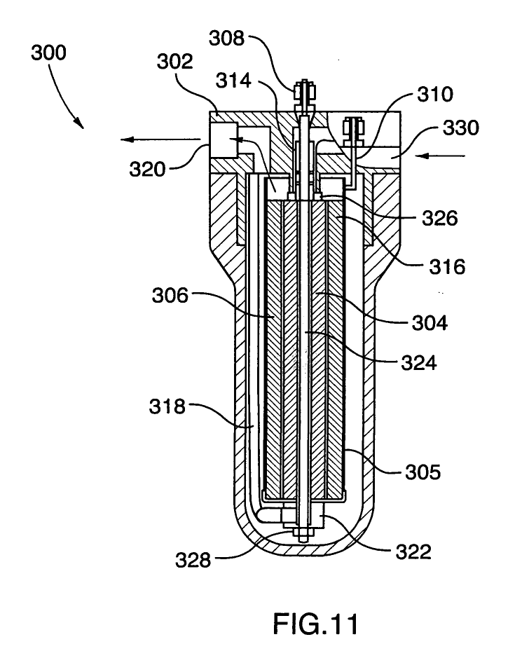

FIG. 11 provides an apparatus for producing uncontaminated water which is free of bacteria and viruses.

The apparatus 300 comprises a filter housing 302 which houses an anode 304, seen as a filter element, a cathode 305 and a filter 306. Two terminals 308 and 310 receive charges in order to charge the anode 304 and the cathode 305. The connection between the anode 304 and the terminal 308 is achieved via anode conducting means 312 comprising a contactor 314 and a washer 316. The housing 302 also houses a sleeve 322 and tubing 324. The filter housing 302 further comprises a means for releasing an anolyte, seen as channel 318 and a means for releasing a catholyte, seen as opening 320.

Locking means, in the preferred embodiment, a plastic stud 326 and a plastic nut 328 are also provided.

In operation, ground or open surface water enters the filter housing 302 via an entrance opening 330 to the inside of an electrically charged channel of the filter element, or anode 304. The filter element is preferably a silver-impregnated carbon block. It is understood that the anode and cathode are provided positive and negative charges, respectively, by applying electrical charges to the terminals 308 and 310. The electrical contact between the filter element 304 and the electrical terminal 308 is provided by the contactor 314 and washer 316.

The minerals or impurities are ionized or oxidized inside the filter element 304 and the treated water pushed through the carbon block filter element 302 and ceramic filter 306. In the present embodiment, the ceramic filter 306 serves as a semi permeable diaphragm having 0.3 micron pores which allows a limited amount of water, approximately a quarter gallons per minute, to travel through therefore, the positive ions travel through the carbon block element 304 and ceramic filter 306 towards the negative electrode, or cathode 305. The treated water exits the housing 302 by means of two flows: the anolyte exits through the channel 318 and the catholyte exits through the opening 320.

The internal assembly of the housing comprising the filter element 302, the ceramic filter 306, the cathode 305, the contactor 314, the sleeve 322 with tubing 324 are held together by the plastic stud 326 and the plastic nut 328.

An advantage of the present invention is that there is no need to store the concentrated disinfecting fluid, no dilution, no dosing equipment and no pressure required to produce disinfecting fluid. Simple modifications in design of the proposed apparatus open the field of additional applications of the present invention. For instance, the disinfecting fluid apparatus (generator) produces acidic fluid that has a pH in a range of between 6.0 and 8.7, oxygen reduction potential in a range of between +500 to +750 mV and Active Chlorine (up to 600 mg/L. This acidic fluid is injected into the water flow to neutralize microbial contamination and oxidize harmful impurities.

Installing a larger diametered cathode and/or having a smaller diametered anode inside the same housing, the generator may produce a catholyte fluid that has a pH between 9.0 and 11.5, oxygen reduction potential (redox) between −500 to −800 mV and no Chlorine. This catholyte fluid can be used for the therapeutic bath or for the industrial purposes, for instance, as a flocculent in the coagulation process.

Advantages of the system of FIGS. 5 and 7 include “no waste” electrolytic (anolyte or catholyte) flows; an electrolytic generator 134 design which produces distinctive valued acidic and alkaline flows through the electrically charged area by arranging the designated circular spaces between the anode 162 and diaphragm 166 and the cathode 164 and diaphragm 166, respectively. In this manner, both flows are used and therefore there is on water wasted.

Also, the media or carbon filter 146 is installed on the pressure side of the combined and mixed (anolyte and catholyte) flow. Also, the selection of materials to manufacture the preferred embodiment of the apparatus provide some advantages. For instance, the anode is preferably an extruded graphite, the cathode is preferably a highly corrosion resistant steel (Alloy 20) that allows a polarization method to be used for cathode cleaning, the diaphragm is preferably an unglazed kaolin pipe. Each of the materials are qualified as food grade materials and are much less expensive then rare earth metals such as zirconium or ruthenium that are used by prior art systems.

It will be understood that the control panel may not be required that the constant positive and negative charges may be applied to the first and second set of electrodes so that the apparatus and system may be continuously operated.

The above-described embodiments of the present invention are intended to be examples only. Alterations, modifications and variations may be effected to the particular embodiments by those of skill in the art without departing from the scope of the invention, which is defined solely by the claims appended hereto.

1. Apparatus for producing a disinfecting fluid comprising:
a housing;
a brine storage chamber, within said housing, for storing a brine solution;
an electrolytic generator within said housing, having a first and a second set of electrodes; and
charge means for providing charges to said first set of electrodes to form an anode and said second set of electrodes to form a cathode thereby creating a current field between said anode and said cathode;
wherein after said current field is established, said brine solution is transmitted through said current field to ionize ions in said brine solution to produce said disinfecting fluid.

2. The apparatus of claim 1 further comprising:
a mixing chamber, within said housing, for producing a brine solution; and
a perforated wall between said mixing chamber and said brine storage chamber.

3. The apparatus of claim 2 further comprising transmission means for transmitting said brine solution from said mixing chamber to said brine storage chamber.

4. The apparatus of claim 2 further comprising:
a brine salt located in said mixing chamber; and
nozzle means for receiving water from a water source and for delivering said water to said mixing chamber to mix with said salt brine to produce said brine solution.

5. The apparatus of claim 1 further comprising discharging means for discharging said disinfecting fluid from said housing.

6. The apparatus of claim 1 wherein said first set of electrodes and said second set of electrodes are circular.

7. The apparatus of claim 1 further comprising a water level control switch, located within said mixing chamber, to detect a level of said water being received from said water source.

8. The apparatus of claim 1 wherein said charge means comprises:
a positive charge source;
a negative charge source;
a first electrical connectivity means for connecting said positive charge source to said first set of electrodes; and
a second electrical connectivity means for connecting said negative charge source to said second set of electrodes.

9. The apparatus of claim 8 further comprising a control panel for controlling level of charges provided by said positive charge source and said negative charge source to said first and second set of electrodes.

10. An in-line system for disinfecting water comprising:
a water source;
apparatus for producing a disinfecting fluid comprising:
a housing;
a brine storage chamber, within said housing, for storing a brine solution;
an electrolytic generator within said housing, having a first and a second set of electrodes; and
charge means for providing charges to said first set of electrodes to form an anode and said second set of electrodes to form a cathode thereby creating a current field between said anode and said cathode;
discharge means for discharging said disinfecting fluid;
wherein after said current field is established, said brine solution is transmitted through said current field to ionize ions in said brine solution to produce said disinfecting fluid;
brine mixing means, connected to said water source, for producing said brine solution for said apparatus; and
water disinfecting means for mixing said discharged disinfecting fluid with water from said water source to produce a treated water.

11. The in-line system of claim 10 wherein said brine mixing means comprises:
a mixing chamber, within said housing, containing a brine salt;
a nozzle for receiving said water from said water source to said mixing chamber for mixing of said water with said brine salt to produce said brine solution;
transmission means for transmitting said brine solution to said brine storage chamber; and
a pump for pumping said water from said water source to said nozzle.

12. The in-line system of claim 10 wherein said brine mixing means comprises:
a pump for pumping said water from said water source;
a brine tank storing a concentrated brine solution;
an injector, connected to an output of said brine tank and said pump for mixing said concentrated brine solution and said water from said water source to form said brine solution;
wherein after said brine solution is produced, said injector injects transmits said brine solution to said brine storage chamber.

13. The in-line system of claim 10 wherein said water disinfecting means comprises:
a pump for pumping water from said water source; and
a mixer, connected to said discharge means and said pump, for mixing said disinfecting fluid and said water from said water source to produce said treated water.

14. The in-line system of claim 13 further comprising a filter for removing solid particulates from said treated water.

15. Apparatus for producing a disinfecting fluid and a therapeutic fluid comprising:
a housing;
a brine storage chamber, within said housing, for storing a brine solution;
an electrolytic generator within said housing, having a first and a second set of electrodes; and
charge means for providing charges to said first set of electrodes to form an anode and said second set of electrodes to form a cathode thereby creating a current field between said first and said second set of electrodes;
wherein after said current field is established, said brine solution is transmitted through said current field to ionize negative ions in said brine solution to said anode to produce said disinfecting fluid and to ionize positive ions in said brine solution to said cathode to produce said therapeutic fluid.

16. The apparatus of claim 1 wherein the first set of electrodes is manufactured from extruded graphite.

17. The apparatus of claim 1 wherein the second set of electrodes is manufactured from a highly corrosive resistant steel.

18. The apparatus of claim 1 wherein the generator further comprises a diaphragm located between said first and second set of electrodes.

19. The apparatus of claim 18 wherein said diaphragm is an unglazed kaolin pipe.
